(19) United States
(12) Patent Application Publication
(10) Pub. No.: US 2022/0155094 A1
(43) Pub. Date: May 19, 2022

(54) Autonomous Vehicle Fixed Environmental Diagnosis

(71) Applicants: Continental Automotive Systems, Inc., Auburn Hills, MI (US); Steering Solutions IP Holding Corporation, Auburn Hills, MI (US)

(72) Inventors: Clinton L. Schumann, Holly, MI (US); Scott T. Sanford, Swartz Creek, MI (US); Geoff Bauer, Oxford, MI (US); Joseph A. LaBarbera, Auburn Hills, MI (US)

(21) Appl. No.: 17/099,885

(22) Filed: Nov. 17, 2020

(51) Int. Cl. G01C 21/00; G07C 5/08; G06K 9/00; G06K 19/06; G06K 7/14; G05D 1/02

(52) U.S. Cl. CPC G01C 21/38; G07C 5/0816; G06K 9/00791; G06K 19/06028; G06K 2007/10504; G06K 7/1413; G06K 7/1417; G05D 1/0278; G06K 19/06037

(57) ABSTRACT

In a number of illustrative variations, a method may include the steps of providing a vehicle that may include at least one sensor; providing at least one signage constructed and arranged to convey a known geolocation of the at least one signage to the at least one sensor; determining a detected geolocation of the vehicle via the at least one sensor; reading the known geolocation of the at least one signage; comparing the detected geolocation to the known geolocation; and identifying discrepancies between the detected geolocation and the known geolocation.

### TECHNICAL FIELD

The field to which the disclosure generally relates to includes vehicle diagnostic systems.

### BACKGROUND

Vehicles may include autonomous driving systems. Autonomous driving systems associated with “self-driving vehicles” may include a single sensor or a plurality of sensors including sensors that measure, read, receive, compile, compute, or otherwise manage data from internal and external sources. Sensors may be used to evaluate vehicle position and recognize local objects. Autonomous driving systems may verify sensor accuracy through internal software or electronic status and system diagnostic checks.

### SUMMARY OF ILLUSTRATIVE VARIATIONS

A number of illustrative variations may include a method or product for system or sensor diagnostic checks in an autonomous driving system.

A product may include an autonomous driving system that may include at least one sensor constructed and arranged to receive and interpret data from local signage to perform system or sensor diagnostic checks in an autonomous driving system or vehicle.

A product may include an autonomous driving system that may include at least one sensor constructed and arranged to receive and interpret data from local signage to perform geographic diagnostic checks in an autonomous driving system or vehicle.

A product may include a vehicle may include at least one sensor; at least one signage; and wherein the vehicle that may include at least one sensor may be constructed and arranged to identify discrepancies between a geolocation of the vehicle and a geolocation of the at least one signage.

A method may include the steps of providing a vehicle that may include at least one sensor; providing at least one signage constructed and arranged to convey a known geolocation of the at least one signage to the at least one sensor; determining a detected geolocation of the vehicle via the at least one sensor; reading the known geolocation of the at least one signage; comparing the detected geolocation to the known geolocation; and identifying discrepancies between the detected geolocation and the known geolocation.

A method may include the steps of providing a vehicle may include a plurality of sensors; providing at least one structure may include at least one signage constructed and arranged to convey a known geolocation of the at least one signage to the plurality of sensors; determining a detected geolocation of the vehicle via the plurality of sensors; reading the known geolocation as conveyed by the at least one signage; comparing the detected geolocation to the known geolocation; and identifying discrepancies between the detected geolocation and the known geolocation.

Other illustrative variations within the scope of this disclosure will become apparent from the detailed description provided hereinafter. It should be understood that the detailed description, while disclosing variations of the invention, is intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 depicts an illustrative variation in which a vehicle that may include at least one sensor may be constructed and arranged to receive and interpret data from local signage in a fixed structure.

FIG. 2 depicts an illustrative variation in which a vehicle that may include at least one sensor may be constructed and arranged to receive and interpret data from local signage.

### DETAILED DESCRIPTION OF ILLUSTRATIVE VARIATIONS

The following description of the variations is merely illustrative in nature and is in no way intended to limit the scope of the invention, its application, or uses.

In a number of illustrative variations, a vehicle for cargo or passengers may be driven ahead by an automotive power derived from a motor that transforms a source of stored energy into a driving force for the vehicle such as but not limited to an internal combustion engine, a battery powered engine, a fuel-cell powered engine, or any other known motor for providing automotive driving power for a passenger or cargo vehicle. The driving force that results from the transformation of stored energy by the motor may be communicated from the motor to a driving medium along which the vehicle will travel such as but not limited to a tract of land, a road, a waterway, an airway, or any other medium along which vehicles are known to travel through space. The communication of the driving force from the motor to the driving medium may occur via any means of driven automotive vehicle movement such as but not limited to road wheels, treads, casters, rollers, propellers, gas thrusters, liquid thrusters, or ion driven thrusters, or any other known means of driven automotive vehicle movement.

In a number of illustrative variations, a vehicle for cargo or passengers may include at least one sensor. The at least one sensor may include any number of sensors associated with autonomous driving systems, vehicles, automobiles, environmental data collection systems, or the like. The at least one sensor may include sensors associated with cargo or passenger vehicles such as, park assist sensors, blind spot detection sensors, surround sensors, collision warning sensors, traffic sign or signal recognition sensors, emergency brake, pedestrian detection, collision avoidance sensors, or cross traffic sensors. The at least one sensor may include radar, lidar, cameras, global positions system (GPS), global navigation satellite systems (GNSS), environmental sensors, or the like. The at least one sensor may perform a variety of functions with respect to detecting, reading, recognizing, or interpreting data associated with local signage.

“Signage,” as used herein, may refer broadly to various displays of information but may also broadly include sensors, devices, or other technologies for conveying information. At least one signage may include fixed signage that may include detectable, readable, recognizable, or interpretable data in the form of, for example but not limited to, QR codes, bar codes, matrix barcodes, alphanumeric codes, symbols, or labels or other non-visual detectable, readable, recognizable, or interpretable data. It is contemplated that the signage may include any means by which data or information may be detectable, readable, recognizable, or interpretable by the at least one sensor. The signage may in any number of physical forms such as an upright street signage, suspended signage, painted, or printed ground signage. The signage may be static, moving, or moveable.

As used herein, “road,” even when modified by a descriptive adjective may refer to a traditional driving surface road such as but not limited to a concrete or asphalt road but may also refer to any driving surface or medium along which or through which a vehicle for cargo or passengers may travel such as but not limited to water, ice, snow, dirt, mud, air or other gases, or space in general.

As used herein, “operating environment” and “structure” may both or individually also refer broadly to roadways, highways, streets, paths, parking lots, parking structures, tunnels, bridges, traffic intersections, residential garages, or commercial garages. It is contemplated that the operating environment may include any location or space accessible by a vehicle.

In a number of illustrative variations, a vehicle may comprise a steering system comprising a steering interface, and a set of steerable road wheels. The steering system may be of the electric power steering type wherein physical linkages mechanically communicate a manipulation of the steering interface to the steerable wheels. The steering system may be of the steer-by-wire type wherein physical mechanisms do not mechanically communicate a manipulation of the steering interface to the steerable road wheels and wherein a manipulation of the steering interface affects an associated manipulation of the steerable road wheels via the communication of electronic devices such as but not limited to sensors, transceivers and electronically excited actuators. In a number of illustrative variations the steering input may include any component that a user or driver may use to steer the vehicle with a portion of the user's or driver's body, which may include at least one hand and/or at least one foot. The steering interface may include, but is not limited to, at least one steering wheel or particular wheel, joy/control stick, one or more foot pedals, or one or more wheel torque or propulsion levers, arms or control devices. Such steering interfaces may be used to control other forms components having a similar function as wheels to steer or propel the vehicle.

In a number of illustrative variations, a vehicle's steering system may also be autonomous in that the vehicle may steer itself toward a predetermined location that has been communicated to it without assistance or interference from a driver. The vehicle's steering system may have an obstacle avoidance system that allows the vehicle to sense objects in its path and avoid them. The vehicle's steering system may have a trajectory planning system that allows the vehicle to plan vehicle path. In some cases, the driver of the vehicle may wish to assist the vehicle in avoiding an object, or to change direction, such as changing driving lanes, of the vehicle without first communicating that wish to the vehicle in some other manner. In such a case, the driver may take control of the driver-side steering system controls and assist the autonomous steering system.

In a number of illustrative variations, a vehicle including an autonomous driving system may be programmed with any number of logic modules arranged to autonomously address a number of areas of control within the realm of vehicle steering and travel including but not limited to vehicle acceleration, vehicle braking, trajectory planning, and an autonomous steering system for control of the vehicle. The vehicle and autonomous driving system may include GPS or GNSS, referred to broadly as geolocation systems, to map trajectory, location, determine speed, acceleration, braking, time, and other various data relating to a vehicle.

In a number of illustrative variations, a vehicle may perform diagnostic tests on at least one sensor such that the vehicle may verify that the at least one sensor is functioning correctly. The vehicle may include data relating to predetermined geolocations of known signage. The vehicle may perform diagnostic tests on at least one sensor by detecting, reading, recognizing, or interpreting local signage at fixed, predetermined geolocations and comparing the read signage to the known, predetermined geolocation of said specific signage. Any variance in data between the read signage and the known, predetermined geolocation may be utilized to diagnose and compensate for inaccuracies or errors in the at least one sensor.

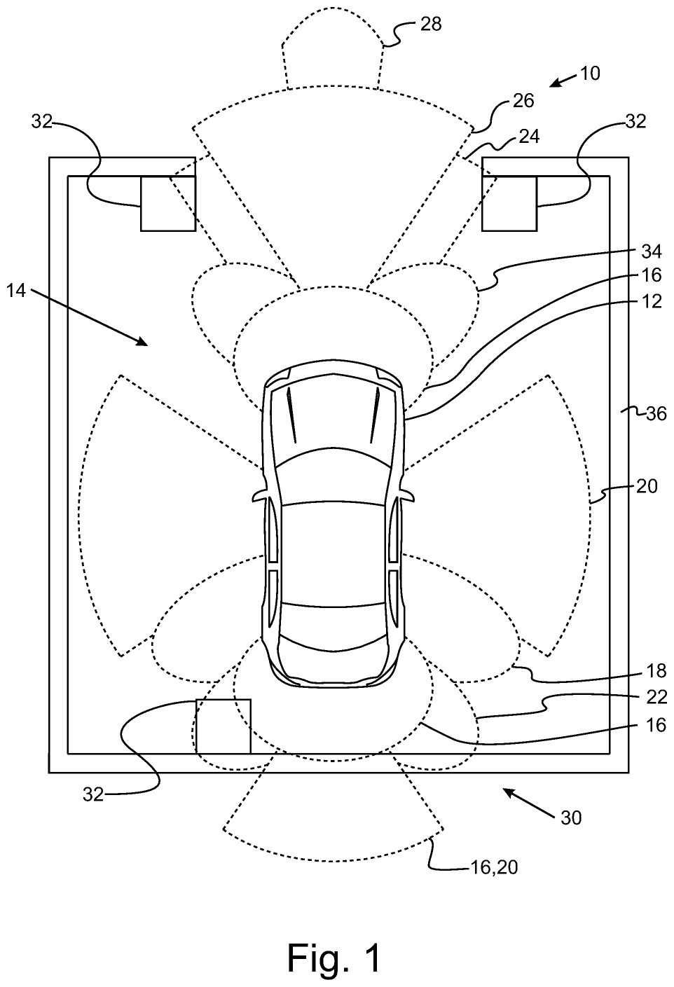

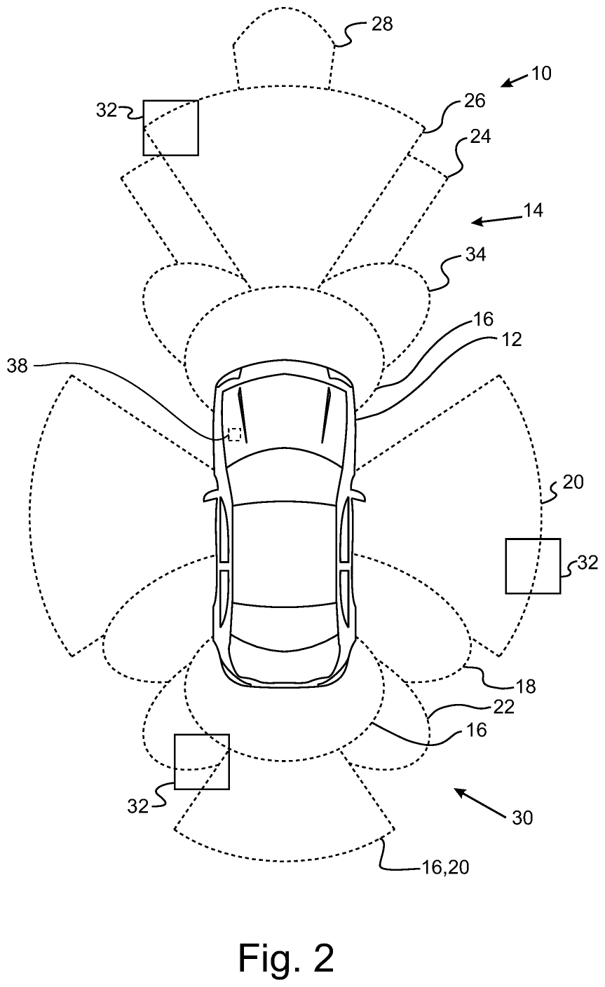

Referring to FIGS. 1 and 2, an illustrative variation in which a vehicle 12 may include an autonomous driving system 10 that may comprise a at least one sensor 14. The at least one sensor 14 may include park assist sensors 16, blind spot sensors 18, surrounds sensors 20, collision warning sensors 22, traffic signal recognition sensors 24, emergency brake, pedestrian detection, or collision avoidance sensors 26, cross traffic sensors 34, or other autonomous driving sensors 28. The vehicle 12 may operate in an operating environment 30 such as roadways, highways, streets, paths, parking lots, parking structures, or garages. It is contemplated that the operating environment 30 may include any location accessible by the vehicle 12. The operating environment 30 may include at least one signage 32 and may include at least one structure 36. The vehicle 12 may be constructed and arranged to rely on the at least one of sensor 14 to detect, read, recognize, or interpret the at least one signage 32. The at least one signage 32 may be constructed and arranged to provide detectable, readable, recognizable or interpretable data relating to the location of the at least one signage 32.

As a non-limiting example and as depicted in FIG. 2, a driver or user of the vehicle 12 may stop or park the vehicle 12 in a structure 36. Alternatively, the driver or user of the vehicle 12 may stop the vehicle 12 at a traffic signal, in a parking lot, or the like. The vehicle 12 may include at least one sensor 14 that may include a geolocation system 38 or geolocation system functionality. The traffic signal or structure 36 may include at least one signage 32 that may be associated with a known geolocation. The vehicle 12 may perform diagnostic tests on at least one sensor by detecting, reading, recognizing, or interpreting the at least one signage 32 at the known geolocation and comparing the read at least one signage 32 data to the known geolocation of the at least one signage 32. The known geolocation of the at least one signage 32 may be stored locally within the vehicle or remotely and may be communicated to the vehicle 12 via a cloud based system or similar system. Any variance between the read signage 32 geolocation and the known geolocation of the signage 32 may be utilized to diagnose and compensate for inaccuracies or errors in the at least one sensor 14. It is contemplated that known changes in the known geolocation of the at least one signage 32 would require a corresponding change in the vehicle 12 and at least one sensor 14 expected signage recognition.

As a non-limiting example and as depicted in FIGS. 1 and 2, a driver or user of the vehicle 12 may start the vehicle 12 in a structure 36. The structure 36 may include at least one signage 32 that may include a known geolocation. The vehicle 12 may perform diagnostic tests on at least one sensor 14 by detecting, reading, recognizing, or interpreting the at least one signage 32 at the known geolocation and comparing the read at least one signage 32 data to the known geolocation of the at least one signage 32. In this way, the vehicle 12 may verify that the at least one sensor is function properly before the driver and vehicle 12 may exit the structure 36.

As an additional non-limiting example, a structure 36 may include at least one signage 32 constructed and arranged to convey at least one known geolocation to at least one sensor 14 of a vehicle 12. The structure 36 may be a residential home, garage, vehicle repair shop, vehicle point of sale, vehicle dealership, or the like. The vehicle may include a geolocation system or geolocation system functionality. A driver may start the vehicle 12 and the vehicle 12 may perform diagnostic tests on the at least one sensor 14 by reading the at least one signage 32 and comparing the read at least one signage 32 geolocation to the known geolocation of the at least one signage 32. In this way, the vehicle 12 may verify that the at least one sensor is functioning properly before the driver and vehicle 12 may exit the structure 36.

The following description of variants is only illustrative of components, elements, acts, product and methods considered to be within the scope of the invention and are not in any way intended to limit such scope by what is specifically disclosed or not expressly set forth. The components, elements, acts, product, and methods as described herein may be combined and rearranged other than as expressly described herein and still are considered to be within the scope of the invention.

Variation 1 may include a product that may include a vehicle that may include at least one sensor; at least one signage; and wherein the vehicle that may include at least one sensor may be constructed and arranged to identify discrepancies between a geolocation of the vehicle and a geolocation of the at least one signage.

Variation 2 may include the product of variation 1 wherein the at least one sensor may be a geolocation sensor.

Variation 3 may include the product in any of variations 1 through 2 wherein the at least one sensor may include geolocation system functionality.

Variation 4 may include the product in any of variations 1 through 3 wherein the at least one signage may include at least one of a QR code, bar code, matrix barcode, alphanumeric code, symbol, or label or other non-visual detectable, readable, recognizable, or interpretable data.

Variation 5 may include the product in any of variations 1 through 4 wherein the vehicle may include at least one sensor may be constructed and arranged to generate an alert signifying the presence of discrepancies between the detected geolocation and the known geolocation.

Variation 6 may include the product in any of variations 1 through 5 wherein the vehicle may include at least one sensor may be further constructed and arranged to adjust the at least one sensor to compensate for discrepancies between the geolocation of the vehicle and the geolocation of the at least one signage such that the at least one sensor correctly detects a geolocation of the vehicle about identical to that of the geolocation of the at least one signage.

Variation 7 may include a method that may include the steps of providing a vehicle that may include at least one sensor; providing at least one signage constructed and arranged to convey a known geolocation of the at least one signage to the at least one sensor; determining a detected geolocation of the vehicle via the at least one sensor; reading the known geolocation of the at least one signage; comparing the detected geolocation to the known geolocation; and identifying discrepancies between the detected geolocation and the known geolocation.

Variation 8 may include the method in variation 7 and may further include adjusting the at least one sensor to compensate for discrepancies between the detected geolocation and the known geolocation such that the at least one sensor correctly detects a geolocation about identical to that of the known geolocation of the at least one signage.

Variation 9 may include the method in any of variations 7 through 8 wherein the at least one sensor may be a geolocation sensor.

Variation 10 may include the method in any of variations 7 through 9 wherein the at least one sensor may include geolocation system functionality.

Variation 11 may include the method in any of variations 7 through 10 wherein the at least one signage may include at least one of a QR code, bar code, matrix barcode, alphanumeric code, symbol, or label or other non-visual detectable, readable, recognizable, or interpretable data.

Variation 12 may include a method that may include the steps of providing a vehicle that may include a plurality of sensors; providing at least one structure that may include at least one signage constructed and arranged to convey a known geolocation of the at least one signage to the plurality of sensors; determining a detected geolocation of the vehicle via the plurality of sensors; reading the known geolocation as conveyed by the at least one signage; comparing the detected geolocation to the known geolocation; and identifying discrepancies between the detected geolocation and the known geolocation.

Variation 13 may include the method in variation 12 and may further include generating an alert signifying the presence of discrepancies between the detected geolocation and the known geolocation.

Variation 14 may include the method in any of variations 12 through 13 further may include adjusting the at least one sensor to compensate for discrepancies between the detected geolocation and the known geolocation such that the at least one sensor correctly detects a geolocation about identical to that of the known geolocation of the at least one signage.

Variation 15 may include the method in any of variations 12 through 14 wherein the at least one sensor may be a geolocation sensor.

Variation 16 may include the method in any of variations 12 through 15 wherein the at least one sensor may include geolocation system functionality.

Variation 17 may include the method in any of variations 12 through 16 wherein the at least one signage may include at least one of a QR code, bar code, matrix barcode, alphanumeric code, symbol, or label or other non-visual detectable, readable, recognizable, or interpretable data.

The above description of select variations within the scope of the invention is merely illustrative in nature and, thus, variations or variants thereof are not to be regarded as a departure from the spirit and scope of the invention.

What is claimed is:

1. A product comprising:
a vehicle comprising at least one sensor;
at least one signage; and
wherein the vehicle comprising at least one sensor is constructed and arranged to identify discrepancies between a geolocation of the vehicle and a geolocation of the at least one signage.

2. The product of claim 1 wherein the at least one sensor is a geolocation sensor.

3. The product of claim 1 wherein the at least one sensor comprises geolocation system functionality.

4. The product of claim 1 wherein the at least one signage comprises at least one of a QR code, bar code, matrix barcode, alphanumeric code, symbol, or label or other non-visual detectable, readable, recognizable, or interpretable data.

5. The product of claim 1 wherein the vehicle comprising at least one sensor is constructed and arranged to generate an alert signifying the presence of discrepancies between the detected geolocation of the at least one signage and the known geolocation of the vehicle.

6. The product of claim 1 wherein the vehicle comprising at least one sensor is further constructed and arranged to adjust the at least one sensor to compensate for discrepancies between the geolocation of the vehicle and the geolocation of the at least one signage such that the at least one sensor correctly detects a geolocation of the vehicle about identical to that of the geolocation of the at least one signage.

7. A method comprising:
providing a vehicle comprising at least one sensor;
providing at least one signage constructed and arranged to convey a known geolocation of the at least one signage to the at least one sensor;
determining a detected geolocation of the vehicle via the at least one sensor;
reading the known geolocation of the at least one signage;
comparing the detected geolocation to the known geolocation of the vehicle; and
identifying discrepancies between the detected geolocation and the known geolocation of the vehicle.

8. The method of claim 7 further comprising adjusting the at least one sensor to compensate for discrepancies between the detected geolocation and the known geolocation such that the at least one sensor correctly detects a geolocation about identical to that of the known geolocation of the at least one signage.

9. The method of claim 7 wherein the at least one sensor is a geolocation sensor.

10. The method of claim 7 wherein the at least one sensor comprises geolocation system functionality.

11. The method of claim 7 wherein the at least one signage comprises at least one of a QR code, bar code, matrix barcode, alphanumeric code, symbol, or label or other non-visual detectable, readable, recognizable, or interpretable data.

12. A method comprising:
providing a vehicle comprising a plurality of sensors;
providing at least one structure comprising at least one signage constructed and arranged to convey a known geolocation of the at least one signage to the plurality of sensors;
determining a detected geolocation of the vehicle via the plurality of sensors;
reading the known geolocation as conveyed by the at least one signage;
comparing the detected geolocation to the known geolocation; and
identifying discrepancies between the detected geolocation and the known geolocation.

13. The method of claim 12 further comprising generating an alert signifying the presence of discrepancies between the detected geolocation and the known geolocation.

14. The method of claim 12 further comprising adjusting the at least one sensor to compensate for discrepancies between the detected geolocation and the known geolocation such that the at least one sensor correctly detects a geolocation about identical to that of the known geolocation of the at least one signage.

15. The method of claim 12 wherein the at least one sensor is a geolocation sensor.

16. The method of claim 12 wherein the at least one sensor comprises geolocation system functionality.

17. The method of claim 12 wherein the at least one signage comprises at least one of a QR code, bar code, matrix barcode, alphanumeric code, symbol, or label or other non-visual detectable, readable, recognizable, or interpretable data.
